(19) United States
(12) Patent Application Publication
(10) Pub. No.: US 2007/0269211 A1
(43) Pub. Date: Nov. 22, 2007

(54) Multiple port symmetric reflective wavelength-selective mesh node

(76) Inventors: Christopher Richard Doerr, Middletown, NJ (US); Gordon Thomas Wilfong, Bedminster, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(21) Appl. No.: 11/434,938

(22) Filed: May 16, 2006

(51) Int. Cl. H04J 14/00

(52) U.S. Cl. 398/49

(57) ABSTRACT

Reflective WSS-based mesh nodes of degree N (i.e., nodes having N ports, where 3<=N<=6) are connected to provide a multiple wavelength channel signal with reciprocal connectivity between the N node ports. The WSS-based mesh nodes of degrees 3 and 4 are implemented using a reflective 1×K WSS, where K is at least equal to 3N-6. Also described are a partitioned degree-4 mesh node and a two-dimensional degree-4 mesh node. For degree-4 mesh nodes, one or more 1×2 directional couplers are used. The degree-5 and -6 nodes are designed by enforcing a symmetric demand constraint and require five 1×4 WSSs and six 1×5 WSSs, respectively. The WSS based degree-3 to -6 mesh nodes offer reduced size and cost.

### CROSS-REFERENCE TO RELATED APPLICATIONS

This application is related to the concurrently filed U.S. patent application Ser. No. ______, Multiple Port Symmetric Transmissive Wavelength-Selective Mesh Node, filed May ______, 2006, attorney docket C. R. Doerr 117-28, which is incorporated by reference herein.

### FIELD OF THE INVENTION

The present invention relates to a wavelength-selective mesh node, and more particularly to a multiple port wavelength-selective mesh node using reflective wavelength-selective switches (WSSs) having symmetric connections.

### BACKGROUND OF THE INVENTION

Today's optical networks are mostly ring-based but are moving toward mesh-based. A mesh architecture has several advantages over a ring architecture, such as more efficient bandwidth utilization, more diverse protection, and less constrained network growth. At the mesh nodes, one would like to be able to route wavelengths arbitrarily, using a wavelength-selective cross connect. The number of fibers entering the node determines its degree.

Wavelength-selective cross connects may be built out of wavelength-selective switches (WSSs). There are two main types of WSSs: transmissive and reflective. In a transmissive WSS, the input is directed in a one-way fashion to one of the K outputs, and the input is clearly distinct from the outputs. An example is the planar lightwave circuit (PLC) 1×9 WSS demonstrated in ^{[1]}. (Note, a reference number in a bracket ^{[]} refers to a publication listed in the attached Reference list.) In a reflective WSS, the input is reflected back by a steering mirror, being directed to one of the K outputs; and the input is not distinct from the outputs. The basic concept of a reflective 1×3 WSS is shown in FIG. 1. An example is the 1×4 WSS demonstrated in ^{[2]}, which used a bulk grating and micro-electro mechanical systems (MEMS) tilt mirrors. Another example is one using a vertical stack^{[3]} or horizontal arrangement[^{4]} of PLCs and MEMS tilt mirrors.

While the designs of such WSS based mesh nodes have proven to be highly flexible their complexity is significant. Thus there is continuing need to simplify the design of WSS based mesh nodes.

### SUMMARY OF THE INVENTION

In accordance with the present invention, we have recognized that by taking advantage of the high flexibility of reflective WSSs and enforcing a symmetric demand constraint, we can simplify the design of WSS based mesh nodes. The present invention utilizes the multiple terminal-pair connection property that exists in existing 1×K reflective WSSs to implement our non-blocking N port optical connection mesh nodes. We disclose WSS based mesh nodes of degree-3 and degree-4 (i.e., nodes having 3 and 4 ports, respectively) implemented using commercially available components. Also disclosed are a partitioned degree-4 mesh node and a two-dimensional degree-4 mesh node. These WSS based mesh nodes are implemented using a 1×K WSS, where K is at least equal to 3N−6, and 3<=N<=4. For degree-3 and degree-4 mesh nodes a set of unique connections between pairs of node ports are established. For degree-4 mesh nodes one or more 1×2 directional couplers are needed.

In accordance with another aspect of the present invention, we have recognized that by taking advantage of the symmetric demand constraint, we can simplify the design of degree-5 and higher WSS based mesh nodes. Using our technique with reflective WSS's, we design degree-5 and -6 nodes that requires five 1×4 WSSs and six 1×5 WSSs, respectively. The WSS port count reduction reduces the size and cost to implement the degree-5 and -6 nodes.

The resulting degree-N mesh nodes, where 3=<N, can provide a total of N!/[2!(N−2)!] unique connections between pairs of node ports (hereinafter, node-port pair connections). The total number of switching states for the node is:
If N is even, the number of states is N!/[(N/2)!*2^{(N/2)}].
If N is odd, the number of states is (N+1)!/[(N+1)/2)!*2^{(N+1)/2}]
For example, for N=3, 4, 5, 6, 7, and 8 the total number of switch states is 3, 3, 15, 15, 105, and 105, respectively.

More particularly we disclose a non-blocking N port optical connection mesh node, 3<=N<=4, for providing a multiple wavelength channel signal with reciprocal connectivity between node ports, comprising

one reflective 1×K WSS apparatus, where K is at least equal to 3N−6, having K+1 or less terminals and switch states being selectable in response to a control signal, where the control signal activates three switch states, one switch state providing a first switch connection of a first terminal-pair and at least one other switch state providing a second switch connection of a second terminal-pair, both terminals in the second pair different than the terminals in the first pair and

node port connection means for providing reciprocal connectivity between each of the N node ports and terminals of the 1×K WSS apparatus, so that the three switch states activated by the control signal provide a set of at least one unique node port-pair connections.

According to another embodiment of the invention, a partitioned four port optical connection mesh node for providing a multiple wavelength channel signal with reciprocal bidirectional connectivity between ports, N=4, the node ports portioned into two sets each set containing two node ports, comprising

one reflective 1×K WSS, having K+1 terminals of which three are directly connected to three of node ports, where K is greater than or equal to N, containing a steerable mirror for each wavelength channel which can be switched to one of K positions, the 1×K WSS is switched to one of two of the K switch states in response to a control signal;

one directional 1×2 coupler connecting 2 predesignated terminals on the 1×K WSS to a preselected one of the node ports; and

wherein each switchable state enables the 1×K WSS to make a connection from any of the 2 node ports in one set to any of the other 2 node ports in the other set.

We additionally specifically disclose a non-blocking N port optical connection mesh node, 5<=N<=6, for providing a multiple wavelength channel signal with reciprocal bidirectional connectivity between node ports, comprising

N port couplers, each being at least a 1×3 directional coupler and having an input port connected to a different one of the N ports, each of 3 output ports connected to one of N reflective 1×K WSSs, where K=N−2;

each of the N reflective 1×K WSSs being responsive to a control signal for establishing a plurality of switching states, the N reflective 1×K WSSs and N port couplers being interconnected so that in response to the establishment of each switch state of the N reflective 1×K WSSs a plurality of unique node port-pair connections are made, and wherein all of the N!/[2!(N−2)!] unique node port-pair connections are made during the plurality of switching states of the N reflective 1×K WSSs.

Other embodiments provide mesh nodes with unidirectional node port and add/drop connectivity.

### BRIEF DESCRIPTION OF THE FIGURES

Other aspects, features, and advantages of the present invention will become more fully apparent from the following detailed description, the appended claims, and the accompanying drawings in which:

FIG. 1 is an illustration of a prior art 1×3 WSS.

FIG. 2 shows our connection dots for illustrating the connections established for different positions of the steering mirror for one wavelength channel of a 1×3 and ×4 WSSs.

FIG. 3 illustratively shows a prior art degree-3 mesh node with local add/drop.

FIG. 4 illustratively shows an embodiment of our inventive degree-3 mesh node with local add/drop.

FIG. 5 illustratively shows a prior art partitioned degree-4 mesh node without local add/drop.

FIG. 6 illustratively shows an embodiment of our inventive partitioned degree-4 mesh node without local add/drop.

FIG. 7 illustratively shows a prior art partitioned degree-4 mesh node with local add/drop.

FIG. 8 illustratively shows an embodiment of our inventive partitioned degree-4 mesh node with local add/drop.

FIG. 9 illustratively shows a prior art reconfigurable optical add-block multiplexer (ROABM) that is often used in prior art add/drop units.

FIG. 10 illustratively shows a prior art omni directional degree-4 mesh node without local add/drop.

FIG. 11 illustratively shows an embodiment of our inventive non-partitioned degree-4 mesh node without local add/drop using a one-dimensional tilt mirror array.

FIG. 12 illustratively shows an embodiment of our inventive non-partitioned degree-4 mesh without local add/drop using a two-dimensional tilt mirror array.

FIG. 13 illustratively shows a prior art non-partitioned degree-4 mesh node with local add/drop.

FIG. 14 illustratively shows an embodiment of our inventive non-partitioned degree-4 mesh node with local add/drop.

FIG. 15 illustratively shows an embodiment of our inventive degree-5 mesh node with bi-directional ports and without local add/drop.

FIG. 16 illustratively shows an embodiment of our inventive degree-5 mesh node having separate unidirectional ports at each location and with local add/drop.

FIG. 17 illustratively shows an embodiment of our inventive degree-6 mesh node with bi-directional ports and without local add/drop.

FIG. 18 illustratively shows an embodiment of our inventive degree-6 mesh node having separate unidirectional ports at each location and with local add/drop.

### DETAILED DESCRIPTION

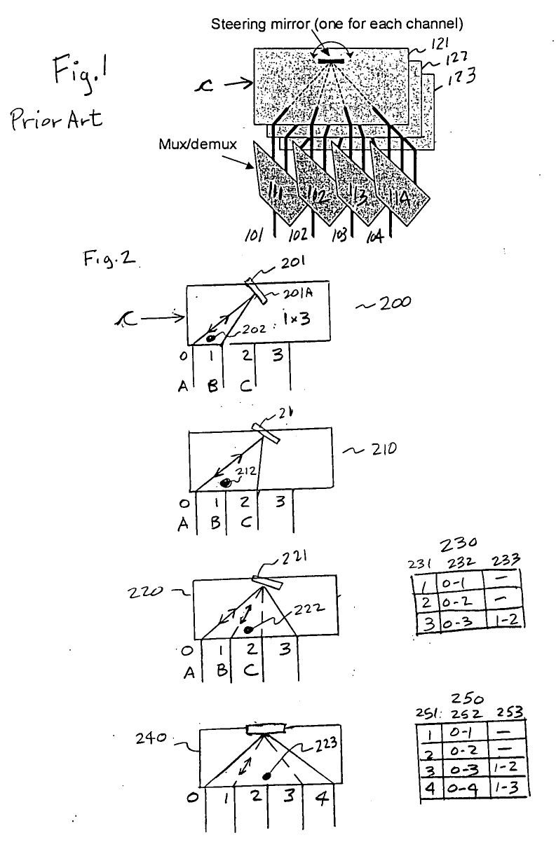

Shown in FIG. 1 is an illustration of a prior art 1×3 WSS, which illustratively handles 3 wavelengths. The 1×3 WSS includes four terminal (or ports) 101-104, each connected to a different Mux/demux unit 111-114 and three 1×3 wavelength channel switches 121-123, each including a steering mirror. When an input Wavelength Division Multiplex (WDM) signal having 3 wavelengths is received at terminal 101 of Demultiplexer 111, each of the 3 wavelengths can be independently switched by one of the steering mirrors 121-123 to one of the three Multiplexers 112-114 for output to one of the terminals 102-104. A separate control signal c is used to switch the position of each of the steering mirrors 121-123. Note that the demultiplexer and multiplexers are all the same type of element, so a multiplexer used backwards is a demultiplexer, and vice-versa. Although we drew a representative 1×3 WSS, the scheme is easily generalized to 1×K by adding more multiplexers/demultiplexers and more possible steering mirror angles.

We have noted that any 1×K WSS can be viewed as a K+1×K+1 WSS with limited flexibility; a reflective WSS exhibits more flexibility than a transmissive one. Current optical networks typically exhibit bidirectional symmetry in their connections^{[5]}, i.e., if location A transmits to location B, then location B transmits to location A on the same circuit. Moreover, today's 1×K WSSs are constructed so that the terminal spacing subtends equal arcs 130 to the mirror 131. One such 1×K WSS is the 1×4 wavelength-selective switch manufactured by JDS Uniphase. We have also noted that such 1×K WSSs exhibit one or more switching states that have more than one pair of symmetrically located terminal-pairs. For example, at a switching state with two symmetrically located terminal-pairs, each terminal-pair represents a separate switched connection that can provide a separate optical signal connection. We have recognized that by taking advantage of the high flexibility of reflective WSSs and enforcing a symmetric demand constraint, we can implement mesh nodes with significantly reduced complexity over conventional designs.

FIG. 2 shows our convention for using a connection dot “•” to illustrate the resulting optical signal connection established for each different switch state (or mirror position) of the 1×3 WSS (200, 210, and 220) and 1×4 WSS (240). The switch state is controlled, illustratively, by control signal c. (Note, to simplify the diagrams the control signal c is not shown in most of the remaining figures.) The connection dot “•” represents a line extending from the center of steering mirror 201A that is normal to the mirror. Using our convention, a connection dot “•”, shown by 202, indicates an optical connection between any two terminals (terminal-pair) that are symmetrically located around the connection dot. Thus, as shown in 200, the first switch state of the 1×3 WSS has a mirror 201 position that enables the bidirectional coupling of signals between terminals 0 and 1, which are shown to be symmetrically located around the connection dot 202. In 220, the second switch state, the position of mirror 211 enables a connection between terminals 0 and 2, which are shown to be symmetrically located around the connection dot 212. In 230, the third switch state, the position of mirror 221 enables a first connection between terminals 0 and 3 as well as a second connection between terminals 1 and 2 (shown in dotted lines in 220). Thus, in the third switch state (mirror position 221) two separate simultaneous terminal-pair connections 0-3 and 1-2 are made. Table 230 shows, for each of the different switch states shown in column 231, the different terminal-pair connections in columns 232 and 233. As shown in columns 232 and 233, only in switch state 3 is a multiple terminal-pair connection property exhibited, the first terminal-pair connection 0-3 and the second terminal-pair connection 1-2. Thus, as shown in table 230, the 1×3 WSS can be considered as including two different switches. The first switch is a 1×3 switch that is a single-pole triple-throw switch (switch states shown in column 232) and the second switch is a single-pole single-throw switch that is switched-on only during state 3 of the 1×3 switch. The present invention utilizes this multiple terminal-pair connection property exhibited by the 1×K WSSs to implement our non-blocking degree-3 through degree-6 mesh nodes.

Shown by 240 is the construction of the 1×4 WSS, which includes terminal 0-4 having four switching states. The first three switching states are the same as shown for the 1×3 WSS, in 200, 210, 220 and Table 230. The fourth switching state, shown by connection dot 223, provides for a first possible terminal-pair connection between terminals 0-4 and a second possible terminal-pair connection between terminals 1-3 (shown in dotted lines). Thus, 1×4 WSS has multiple switching states, 3 and 4, that exhibit a multiple terminal-pair connection property. Table 250 shows that for 1×4 WSS, the switching states 1-3 (column 251) have the same terminal-pair connections as the 1×3 WSS, as shown in table 230. In switching state 4, there is the first terminal-pair connection 0-4 and a second terminal-pair connection 1-3. The present invention utilizes this multiple terminal-pair connection property exhibited by the 1×3 WSS to implement our degree-5 non-blocking N port mesh node and uses the 1×4 WSS to implement our degree-6 non-blocking N port mesh node.

### Degree-3 Nodes

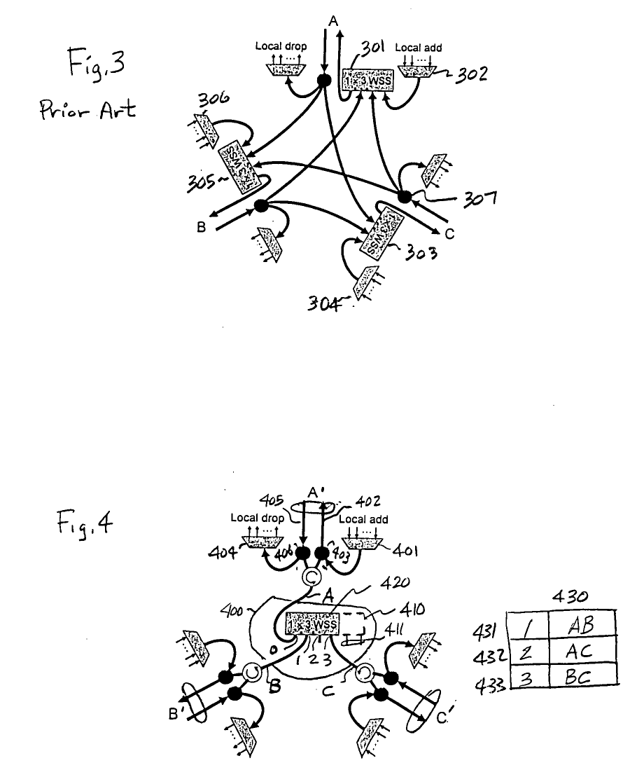

FIG. 3 shows a prior art design of a degree-3 mesh node with local add/drop capability. The degree-3 mesh node is made using three reflective 1×3 WSSs, e.g., 301, one for each port location. One or more wavelengths of a WDM signal (also referred to as traffic) coming from one of the three locations (or mesh node ports) A, B, C can be routed to either of the other two locations or be dropped and added locally. Generally, a degree-N mesh node, having N ports, can provide a total of N!/[2!(N−2)!] unique node port-pair connections. Since N=3 for a degree-3 mesh node, three unique node port-pair connections A-B, A-C, B-C can be made.

Each of the WSSs is reflective ones, and all the WSSs depicted in this application are of the reflective type. As previously noted, the small connection dots inside the WSS represent the possible mirror tilt angles. Each dot represents one state of the WSS for a given wavelength. Dots can be independently chosen for each wavelength. Ports that are symmetric about a dot make an optical connection. For example, the left-most dot in the upper 1×3 WSS, 301 of FIG. 3, means location A will receive the given wavelength from location B (i.e., the B-A connection). The center dot in the upper 1×3 WSS makes the C-A connection. The right-most dot in the upper 1×3 WSS makes both the B-C connection and the Local add Mux 302 connection. Similarly, the dots of WSS 303 enable the A-B, A-C, B-C, and Local add Mux 304 connections and the dots of WSS 305 enable the A-B, A-C, B-C, and Local add Mux 306 connections. The large dots, e.g., 307, represent optical couplers. Note that the Local add Muxes (e.g., 302) all connect to an outgoing fiber of a node port (i.e., A) via a 1×3 WSS (i.e., 301)

The prior art design of FIG. 3 is highly flexible in that a given wavelength coming from port A can be routed to B while simultaneously that same wavelength coming from B can be routed to A or C. However, such asymmetric connection flexibility may needlessly complicate networks. For example, asymmetric connections would likely mean that transceivers would transmit on a different wavelength than they receive. Load-balanced networks, especially, may not need such flexibility. We have recognized that if we give up the asymmetric flexibility and enforce symmetric demands, e.g., if a wavelength is routed from A to B then it must also be routed from B to A, then we can greatly simplify the hardware required to make the node. Our inventive degree-3 mesh node with local add/drop is shown in FIG. 4.

As shown in FIG. 4, instead of three 1×3 WSSs as required in prior art FIG. 3, our degree-3 mesh node needs only one 1×3 WSS unit, shown by 400. WSSs with a K larger than 3 could also be used, and in all the following figures that depict our invention, we show the WSS with the minimum required K. Of course, when K is greater than 3 only three of the K switching states are used in our degree-3 and degree-4 Mesh nodes designs.

In comparison to the prior art degree-3 mesh node of FIG. 3 that required one 1×3 WSS for each port location, we now require only one “centralized” 1×3 WSS that interconnects to all three ports A, B, and C. The one 1×3 WSS unit 400 is shown to include a 1×3 WSS switch 420 and a novel connection arrangement between the three nodes A, B, and C and three terminals of the 1×3 WSS switch 420. The 1×3 WSS switch 420 has four terminals 0-3, and three selectable switch states (depicted as the left, center, and right connection dots). Each switch state provides an optical connection path between a pair of terminals. As shown in FIG. 2, for the three states the terminal connection paths are 0-1, 0-2, and 0-3 (with the third state also providing another symmetric terminal-pair connection path 1-2). Note that the terminal connections for all three switching states include the terminal “0” coupled to a different one of the three other terminals 1, 2, or 3. This standard type of terminal connection paths are 0-1, 0-2, and 0-3 was used in the prior art FIG. 3 mesh node design. We have recognized that by arranging the node port connections to the 1×3 WSS switch 420 so that in switch state three (the right-most dot in 420) we do not utilize the terminal connection path 0-2, but rather to use the terminal connection path 1-3 in one of the switching states, that we could simplify the design of the degree-3 mesh node. As shown in FIG. 4, the third switch state does not use the terminal “0”, but rather uses terminals 1 and 3. The 1-3 terminal connection is symmetric about the right-most connection dot (that represents the third switching state) and is referred to as a symmetric terminal connection pair. The connection arrangement of FIG. 4 provides for connecting each node port to a different terminal of the 1×3 WSS, where at least one pair of node ports connects to the symmetric terminal connection pair (terminals 1 and 3). In this manner, the different node port connection are as shown in table 430, where in the first state a connection is established between node ports A-B, in the second state a connection is established between node ports A-C, and in the third state a connection is established between node ports B-C.

The FIG. 4 degree-3 mesh node saves significant cost, space, and fibering. Our FIG. 4 degree-3 mesh node is designed so that when a channel is being routed between two locations (e.g., A to B), the connection to the third location (i.e., C) is blocked so that it can be dropped and added. The 1×3 WSS apparatus, shown by 400, is a non-blocking 3 port optical connection mesh node for providing one channel of a multiple wavelength channel signal with reciprocal connectivity between node ports A, B, and C. Note that only three (0, 1, and 3) of the four terminals of the 1×3 WSS are connected to ports A, B, and C. The steerable mirror of the 1×3 WSS is switched to one of three positions, as denoted by the left, center, and right connection dot “•”. The 1×3 WSS is switchably controlled by a control signal (not shown) to enable a reciprocal connection to be established between each unique pair of node ports (i.e., AB, AC, BC) by switching the mirror to one of the three states (or positions). Thus, in the first switching state (left connection dot) a connection is made between ports AB (since the terminals 0 and 1 are symmetrically located around the left connection dot). In the second switching position (center connection dot) a connection is made between ports AC (since the terminals 0 and 3 are symmetrically located around the center connection dot). In the third switching position (right connection dot) a connection is made between ports BC (since the terminals 1 and 3 are symmetrically located around the right connection dot). In table 430 there is shown the different node port connection pair that is established in each of the three states 431, 432, and 433.

If connections are to be made to unidirectional facilities as shown by A′, B′, and C′ then optical circulators are used to convert the bidirectional signals from the bidirectional ports A, B, and C. The well-known optical circulators are shown as white circles containing a counterclockwise circular arrow. In an optical circulator, if you enter one port (e.g., 1), you exit from a second port (e.g., 2, located in the counterclockwise direction from port 1). If you enter the second port, you exit from the third port (e.g., 3). Note that the Local Add Muxes (e.g., 401) connect to an outgoing fiber (i.e., 402) at each node port (i.e., A) via coupler (i.e., 403). Similarly, the Local Drop Demuxes (e.g., 404) connect from an incoming fiber (i.e., 405) at each node port (i.e., A) via coupler (i.e., 406).

However, besides having a symmetric demand constraint, we have two other drawbacks. The first is that we can no longer use the WSSs as dynamic gain equalization filters (DGEFs). Actually, WSSs can be made at a significantly lower cost if they do not need to perform a DGEF function. With controllable optical amplifiers, one can match the channel powers from two locations entering the nodes, and the add multiplexer can contain variable optical attenuators (VOAs), so loss of DGEF functionality is not a major limitation. The other drawback is that the node now has a single point of failure, the 1×3 WSS. However, we still have full protection for the add/drop channels (because they do not connect to the network through the WSS), and the loss of a node in a mesh network can be readily compensated for by re-routing at other nodes. Thus this is not a major limitation either.

While the degree-3 mesh node has been shown to include a 1×3 WSS, it should be noted that any 1×K, where K is greater than or equal to 3 can be used, with the additional terminals left unconnected. Of course, when K is greater than 3 only three of the greater than three switching states are used in our degree-3 and degree-4 mesh nodes designs. This is shown illustratively in dotted line form, 410, where a 1×5 WSS is utilized with no connections to its last two terminals 411. Of course, when K is greater than 3 only three of the K switching states are used in our degree-3 design.

### Partitioned Degree-4 Nodes

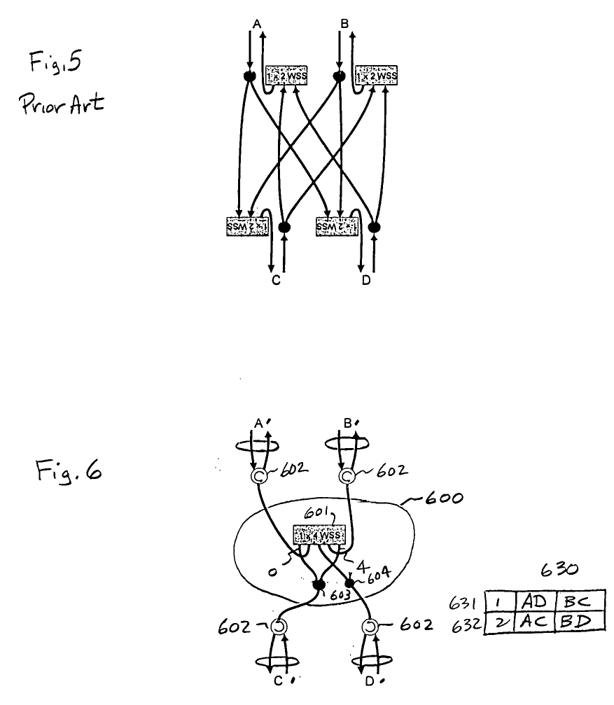

Degree-4 nodes have more variations than degree-3 nodes. In this section we discuss “partitioned” degree-4 nodes, and a conventional design without local wavelength add/drop is shown in FIG. 5. The design uses four 1×2 WSSs. The node ports are partitioned into two sets (or groups), set AB and set CD. There is connectivity between sets but no connectivity within a set. Thus, a partitioned node has limited flexibility: e.g., traffic from A can be routed to C and/or D, but cannot be routed to B. A partitioned degree-4 node might be used to couple two network rings together.

Our simplified design for a partitioned degree-4 node without local wavelength add/drop is shown in FIG. 6. Instead of four 1×2 WSSs, we now need only one 1×4 WSS, shown by 601. The 1×4 WSS, 601, provides a multiple wavelength channel signal with reciprocal bidirectional connectivity between node ports A, B, C, and D. The node ports portioned into two sets (AB and CD) each set containing two node ports. If connection is desired to unidirectional ports A′, B′, C′, and D′, then we additionally need four circulators, 602, one for each node port, and a 0.50 1×2 coupler, 603, to connect the circulator of node port C to the outside terminals (0 and 4) of the 1×4 WSS. Our design saves cost, size, and fibering. To balance the transmission losses through the 1×4 WSS a “dummy” 0.50 coupler 604 (e.g., a 1×2 coupler with one output port not connected) or 3db attenuator is added. Not including circulator losses, the insertion loss is the same for both FIGS. 5 and 6. The left-most dot of the 1×4 WSS makes the symmetrical connections A-D, B-C, and the right-most dot makes the symmetrical connections A-C, B-D. Thus, the 1×4 WSS switches between only 2 mirror positions, each position enables the WSS to make two separate simultaneous connections from any of the 2 node ports in one set (A, B) to any of the other 2 node ports in the other set (C, D). For example as shown in table 630, in the first switch (mirror) position (left dot), 631, the two separate simultaneous connections are A-D and B-C. In the second switch (mirror) position (right dot), 632, the two separate simultaneous connections are A-C and B-D. Note no connections are possible between A and B or between C and D. The 1×4 WSS is switchably controlled by a control signal (not shown).

While the degree-4 mesh node has been shown to include a 1×4 WSS, it should be noted that any 1×K, where K is greater than or equal to 4 can be used, with the additional terminals left unconnected. In the same manner as illustrated in FIG. 4, the 1×4 WSS can be replaced by, for example, a 1×5 WSS with no connections to its extra terminal. Again, when K is greater than 4 only three of the K switching states are used in our degree-4 design.

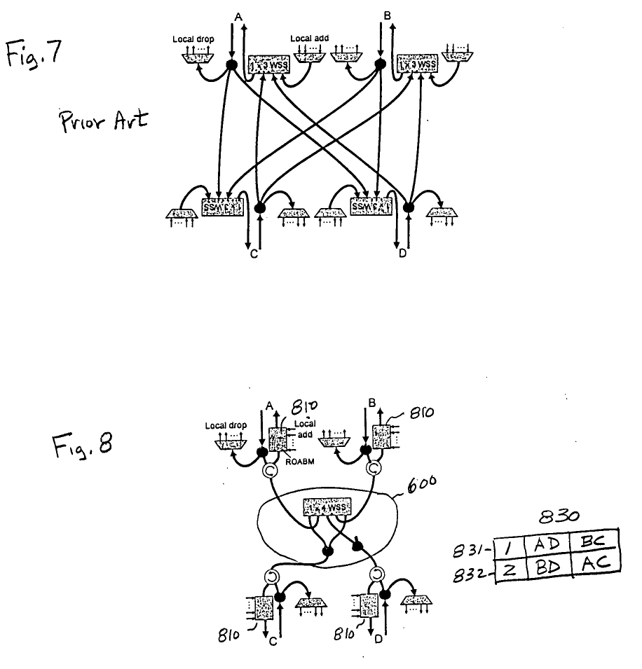

FIG. 7 shows a conventional partitioned degree-4 node with local add/drop. Channels can be locally dropped and added (with drop and continue if desired) or sent through the node.

FIG. 8 shows our simplified design for a partitioned degree-4 node 600 with local add/drop. The main new aspect is that we use a “ROABMs” (reconfigurable optical add-block multiplexers), shown as 810. A ROABM is a well-know device that can either pass a channel or block it and add a new one. ROABMs are often used in conventional add/drop units. Each ROABM in FIG. 8 replaces a multiplexer in FIG. 7, and if the ROABM is made using PLC technology, the additional cost should be low compared to the cost of a 1×2 WSS. In this manner, the different node port connection are as shown in table 830, where in the first state, 831, a connection is established between node ports A-D and BC and in the second state, 832, a connection is established between node ports B-D and A-C.

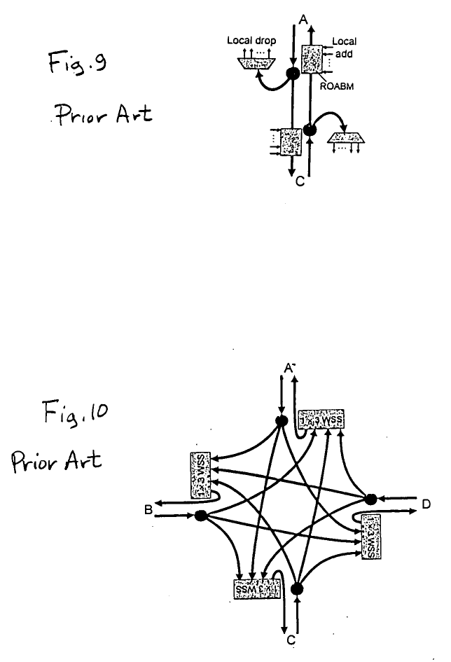

ROABMs are often used in conventional add/drops, as shown in FIG. 9. Thus the architecture of FIG. 8 the gracefully change from a conventional add/drop node, such as FIG. 9, into a mesh node of FIG. 8. By gracefully, we mean that no initial investment in equipment is lost, and transceivers do not have to ever be disconnected from the network. This is unlike the conventional mesh node design of FIG. 7, in which one would need to anticipate turning an initial add/drop node into a mesh node. In such a case, one would have to build the initial add-drop node using WSSs and multiplexers and reserve valuable ports on the WSSs for the possible future mesh.

### Degree-4 Nodes

A conventional design for a degree-4 node (non-partitioned) without local add/drop is shown in FIG. 10. Traffic can be routed from any direction to any other direction (except back to the direction from which it came, which is probably not needed in networks).

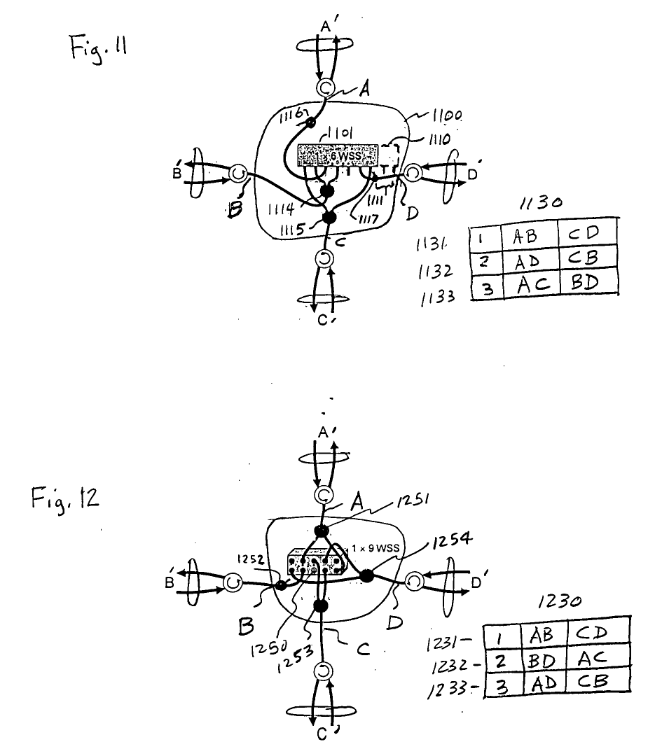

FIG. 11 shows our simplified node without local add/drop. We have replaced four 1×3 WSSs with one 1×6 WSS, again saving significant cost, size, and fibering. Also, the worst-case insertion loss (ignoring the circulator loss) is reduced (4.8 dB excess loss for the conventional design, 4.2 dB excess loss for the proposed design). A proof that the design of FIG. 10 is optimal, in that it must contain at least two splitters and the WSS must have at least seven ports, is given in the Appendix.

The 1×6 WSS unit, shown by 1100, includes a 1×6 WSS switch and four directional 0.50 couplers 1114-1117 (note, dummy couplers 1116 and 1117 could each be replaced by a 3db attenuator). The 1×6 WSS unit is a non-blocking 4 port optical connection mesh node for providing one channel of a multiple wavelength channel signal with reciprocal connectivity between node ports A, B, C, and D. As noted previously, for a 4 port mesh node a total of 4!/[2!(4−2)!] or 6 unique node port pair connections must be made by the 1×6 WSS apparatus. Note that only terminal 4 (of the 7 terminals number left to right as 0-6) of the 1×6 WSS apparatus is unconnected. Two of the terminals (2 and 5) are directly connected to node ports A and D, respectively. The node port B connects via 1×2 directional coupler 1114 to terminals 1 and 3 of the 1×6 WSS apparatus. The node port C connects via 1×2 directional coupler 1115 to terminals 0 and 6. The steerable mirror of the 1×6 WSS is switched to one of three positions (or states), as denoted by the left, center, and right connection dot “•”. The 1×6 WSS is switchably controlled by a control signal (not shown) to enable a reciprocal connections to be established between six unique pairs of node ports (i.e., AB, AC, AD, BC, BD, BC) by switching the mirror to one of the three positions. Thus as shown in table 1130, in the first switching state, 1131, (left connection dot) a two simultaneous connections are made between ports A-B and C-D (since two sets of terminals 3 and 4 as well as 0 and 6 are symmetrically located around the left connection dot). In the second switching state, 1132, (center connection dot) a connection is made between ports A-D and B-C (since the terminals 2 and 5 as well as 1 and 6 are symmetrically located around the center connection dot). In the third switching state, 1133, (right connection dot) a connection is made between ports B-D and A-C (since the terminals 3 and 5 as well as 2 and 6 are symmetrically located around the right connection dot). In this manner, a reciprocal connection is established between each unique pair of node ports by switching the mirror of 1×6 WSS to one of the three positions.

While the degree-4 mesh node has been shown to include a 1×6 WSS, it should be noted that any 1×K, where K is greater than or equal to 6 can be used, with the additional terminals left unconnected. This is shown illustratively in dotted line form, 1110, where a 1×8 WSS is utilized with no connections to its last two terminals 1111. Of course the extra two unused terminals can also be located on the other side or one unused terminal can be on each side. Of course, when K is greater than 6 only three of the K switching states are used in our degree-4 design.

Some 1×K WSSs are made using two-dimensional arrays of ports (or terminals). In such a case, one could use the 1×9 WSS two-dimensional array design (a 1×5 on each level) shown by 1100 in FIG. 12. Again, connections are made symmetrically about the connection dots. For example as shown in table 1230, the first switch state, 1231, is represented by the left-most dot in FIG. 12, located in between the two rows (or levels), which depicts connections A-B, C-D, the second switch state, 1232, is represented by the right-most dot (between the two rows), which depicts connections B-D, A-C, and the third switch state, 1233, is represented, illustratively, by the dot, 1259 (in the third white circle on the lower level), which depicts connections A-D, C-B. Four directional 0.50 couplers 1251-1254 are used at node ports A-D. Note, the dummy coupler 1252 at node port B can be replaced by a 3db attenuator.

Again, while this degree-4 mesh node has been shown to include a 1×9 WSS having two-dimensional arrays of ports, a 1×5 on each level, a larger two-dimensional array of ports with a 1×6 (or more) on each level can be used. In such an arrangement, the extra unused terminals could be located on either side or both sides (if, e.g., a 1×7 is used on each level). Again, notwithstanding the extra terminals on each level, only three of the switching states are used in our degree-4 design.

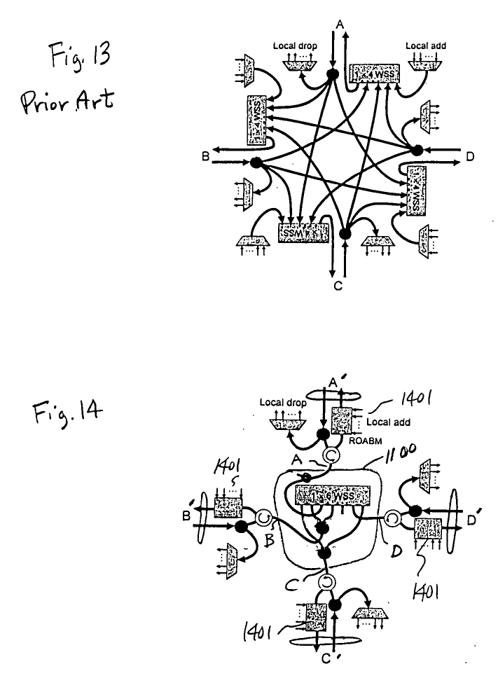

FIG. 13 shows a conventional design for a degree-4 node with local add/drop.

FIG. 14 shows our simplified design for a degree-4 node with local add/drop. As in the partitioned degree-4 node, we need to use ROABMs, 1401. Also, this architecture allows one to gracefully grow to a mesh node from a conventional add/drop such as the one shown in FIG. 9.

It should be understood that this invention is not limited to the particular embodiments disclosed, but it is intended to cover modifications within the spirit and scope of the present invention as defined by the appended claims.

### Degree-5 and -6 Nodes

For mesh nodes of degree higher than four, more than one steering mirror per wavelength is needed. This is because for such nodes, it is possible that one connection for a given wavelength must remain intact while another connection for the same wavelength must be rerouted. Today's commercially available WSSs have only one steering mirror per wavelength, so we must construct nodes of degree higher than four by using a plurality of WSSs.

Conventional designs for degree-5 and -6 nodes follow the pattern of the degree-3 and -4 nodes described above. If we ignore local add/drop, then the prior art arrangements of five 1×4 WSSs and six 1×5 WSSs would be required to construct degree-5 and -6 nodes, respectively. For even higher degrees the prior art pattern continues, requiring N 1×(N−1) WSSs for a node of degree N.

In accordance with the present invention, we have recognized that by taking advantage of the high flexibility of reflective WSSs and enforcing a symmetric demand constraint, we can simplify the design of degree-5 and degree-6 WSS based mesh nodes. By applying the constraint of symmetric demands, we have discovered that we can reduce the size of the WSSs needed for a node of degree-5 and -6. Using our technique, we design a degree-5 and -6 nodes that requires five 1×4 WSSs and six 1×5 WSSs, respectively. The WSS port count reduction reduces the size and cost to implement the degree-5 and -6 nodes. The resulting degree-N mesh node, having N ports, 5=N=6, can provide a total of N!/[2!(N−2)!] unique node-port pair connections.

By applying the constraint of symmetric demands, we require only N1×(N−1)/2 WSSs for a node of degree N, again ignoring local add/drop. This is possible because each WSS needs to connect to only half of the nodes, the other WSSs being responsible for the connections to the other half of the nodes. Actually, there are many possible designs, a necessary criterion being that for the N1×Kᵢ WSSs being used

$${\sum }_{i = 1}^{N} {K}_{i} \geq N ( N - 1 ) / 2.$$

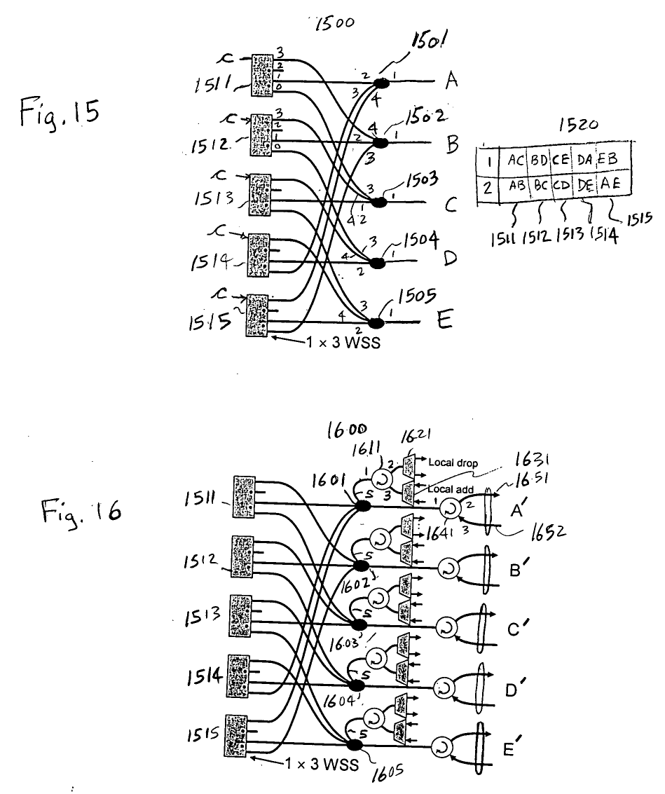

It should be noted, for higher degree nodes than 4, for the designs considered here, we can no longer take advantage of the multiple connection property of reflective WSS's. In fact the multiple connection property creates stray, unwanted connections. Moreover, since with designs using reflective WSS's, the stray connections become almost unmanageable for nodes with degree higher than 6, so we present reflective WSS nodes with degree up to only 6. Our designs for degree-5 and -6 nodes using reflective WSSs are shown in FIGS. 15 & 16 and 17 & 18, respectively.

Using reflective WSS's, our degree-5 node design requires only five 1×3 WSSs, and the degree-6 nodes requires only six 1×4 WSSs, thus saving WSS port count (but not WSS count) over the conventional design. The insertion loss is reduced as compared to the conventional design because there is less power splitting. The degree-5 and -6 nodes WSSs in these designs must be able to switch in a hitless fashion and must be able to extinguish the signal (i.e., make no connections at all).

More generally in accordance with the present invention, when reflective WSS's are employed, we describe a non-blocking N port optical connection mesh node, 5<=N<=6, for providing a multiple wavelength channel signal with reciprocal connectivity between node ports, comprising (1) N port couplers, each being at least a 1×3 directional coupler and having an input port connected to a different one of the N ports, each of the 3 output ports connected to one of N reflective 1×K WSSs, where K=N−2 and (2) where each of the N reflective 1×K WSSs are responsive to a control signal c for establishing a plurality of switching states, the N reflective 1×K WSSs and N port couplers being interconnected so that in response to the establishment of each switch state of the N reflective 1×K WSSs a plurality of unique node port-pair connections are made, and wherein all of the N!/2!(N−2)! unique node port-pair connections are made during the plurality of switching states of the N reflective 1×K WSSs.

With reference to FIG. 15 we describe our degree-5 non-blocking mesh node 1500 where each of the node ports A-E provides a bidirectional facility connection and does not include an add/drop capability. Each of the bidirectional ports A-E couples the wavelengths of a multiple wavelength WDM signal (also referred to as traffic) to one of the 1×3 directional coupler 1501-1505, respectively. Each of the couplers provide connection to three different 1×3 WSSs of the five 1×3 WSSs 1511-1515. Again the connection dots shown in the five 1×3 WSSs illustrate the various connections that occur in the three switching states for each wavelength. For each of the five 1×3 WSSs 1511-1515, the terminals are numbered from bottom to top as terminals 0-3. Two switching states are represented by the bottom and top connection dots. The third state extinguishes the signal. As discussed below there is a particular repeating pattern in the connections between the five couplers, 1501-1505, and the five 1×3 WSSs, 1511-1515.

In FIG. 15 the five node ports A-E, five couplers 1501-1505, and five 1×3 WSSs 1511-1515 are shown arranged in column form. Each location or position is associated with (or connected to) one node port (e.g., node A), one coupler (i.e., coupler 1501), and one 1×3 WSS (i.e., 1511). A control signal c is used to select the switching state of each 1×3 WSS. However, to simplify FIG. 15 a control signal c is shown only for 1×3 WSS 1511, although it should be understood that each of the other 1×3 WSSs 1512-1515 would also have a control signal c connected to each of them. The 1×3 WSS 1511 has its terminals numbered 0-3 from bottom to top. Thus the bottom terminal one is numbered 0, the second terminal is numbered 1, etc. The other 1×3 WSSs, 1512-1515, are similarly numbered, although to avoid crowding of FIG. 15, the terminal numbers have not been shown. The couplers all follow a repeatable predefined connection arrangement to the three 1×3 WSSs that they connect to. For the purposes of our discussion of the repeatable predefined patterns of interconnection between the couplers 1501-1505 and the 1×3 WSSs, 1511-1515, we describe the numbering positions of the 1×3 WSSs, 1511-1515, as being in positions 1 to 5 and the next position count beyond 5 would “wrap around,” (as in a modulo-5 counter) to position 1. Thus for example, the 1×3 WSS in position 4 (1514) in the column is located three positions away from the 1×3 WSS in position 1 (1511) and the 1×3 WSS in position 1 (1511) is located three positions away from the 1×3 WSS in position 3 (1513). Using this convention we now describe the repeatable predefined connections between the couplers 1501-1505 and the 1×3 WSSs, 1511-1515.

In FIG. 15, the first coupler, e.g., 1501, has a first terminal connected to a node port A and a second terminal connected to a second terminal (shown as 1) of a first 1×3 WSS, e.g., 1511. A third terminal of the coupler, 1501, connects to a first terminal (shown as 0) of a fourth 1×3 WSS, i.e., 1514. A fourth terminal of the coupler, 1501, connects to a fourth terminal (shown as 3) of a fifth 1×3 WSS, i.e., 1515, in the column.

The second coupler, e.g., 1502, has its first terminal connected to a node port B and a second terminal connected to a second terminal (shown as 1) of a second 1×3 WSS, e.g., 1512. having the same relative column position (second position) as the node port B's column position. A third terminal of the coupler, 1502, connects to a first terminal (shown as 0) of a fifth 1×3 WSS, i.e., 1515. Note that like the third terminal of coupler 1501, the third terminal of coupler 1502, also connects to a 1×3 WSS (i.e., 1515) that is located three positions from the 1×3 WSS (i.e., 1512) where the second terminal of coupler 1502 connects. A fourth terminal of the coupler, 1502, connects to a fourth terminal (shown as 3) of the first 1×3 WSS, i.e., 1511. Again like the fourth terminal of coupler 1501, the fourth terminal of coupler 1502, also connects to a 1×3 WSS (i.e., 1511) that is located one positions from the 1×3 WSS (i.e., 1515) where the third terminal of coupler 1502 connects.

The above connection pattern of the various terminals of each of the remaining couplers 1503-1505 proceeds in the same manner as discussed above. That is, the second terminal of a coupler connects to terminal 1 of a 1×3 WSS that is in the same relative position as the coupler. The third terminal of a coupler connects to a terminal 0 of a 1×3 WSS that is three positions below it. And the fourth terminal of a coupler connects to a terminal 3 of a 1×3 WSS that is one position below it.

To couple a signal from port A to port B requires that control signal c set the switch state corresponding to the top connection dot of 1×3 WSS 1511. The signal from port A is then coupled via coupler 1501 to and switched from terminal 1 to terminal 3 of 1×3 WSS 1511 through coupler 1502 to port B. To couple a signal from port A to port C requires that control signal c set the switch state corresponding to the lower connection dot of 1×3 WSS 1511. The signal from port A is then coupled via coupler 1501 to and switched from terminal 1 to terminal 0 of 1×3 WSS 1511 through coupler 1503 to port C. In a similar manner, to couple a signal from port A to port D requires that control signal c set the switch state corresponding to the lower connection dot of 1×3 WSS 1514. The signal from port A is then coupled via coupler 1501 to and switched from terminal 0 to terminal 1 of 1×3 WSS 1514 through coupler 1504 to port D. Similarly, to couple a signal from port A to port E requires that control signal c set the switch state corresponding to the upper connection dot of 1×3 WSS 1515. The signal from port A is then coupled via coupler 1501 to and switched from terminal 3 to terminal 1 of 1×3 WSS 1515 through coupler 1504 to port E. The remaining port connections, as shown in FIG. 15, proceed in a similar manner so that each of the ports can connect to any of the other ports. As a result the mesh node of FIG. 15 enables ten unique node-port pair connections (N!/[2!(N−2)!], where N=5). The ten unique node-port pair connections are shown in Table 1520, which shows the node-port pair connections for each of the 1×3 WSSs, 1511-1515, when they are in state 1 or 2. The node-port pair connections for 1×3 WSSs, 1511-1515, in state I are AC, BD, CE, DA, EB and in state 2 the node-port pair connections are AB, BC, CD, DE, AE. In actual operation, all of the 1×3 WSSs 1511-1515 are not in the same state. Thus for example, a signal at node port A that is to be switched to only node port B would have WSS 1511 in state 2, WSS 1514 in state 1, and WSSs 1512-1514 in either state 1 or 2.

While the degree-5 mesh node of FIG. 15 has been described as using five 1×3 WSSs it should be understood that, more generally, any larger 1×K WSSs may be used, i.e., where K is larger than 3 and where the additional terminals are left unconnected. Additionally, the additional unconnected terminal(s) may be located at either end or both ends of the WSSs. Of course when K is greater than 3, only two of the K switching states are used, the same switching states as used in the five-1×3 WSSs embodiment of FIG. 15.

FIG. 16 illustratively shows an embodiment of our inventive degree-5 mesh node having separate unidirectional ports, e.g., A′ and a local add/drop capability at each location. It should be noted that separate unidirectional ports, e.g., A′ and/or a local add/drop capability can be provided at less than all of the five port locations A-E. The add/drop capability requires that five terminal couplers 1601-1605 be used, where the fifth terminal connects to port one of circulators 1611 to 1614, respectively. The second port of each of the circulators, e.g., 1611, connects to one of the local drop demultiplexer, e.g., 1621. The third port of each of the circulators 1611-1615 connects to one of the local add multiplexer, e.g., 1631. To provide connection to two unidirectional ports, e.g., A,′ from a bidirectional port A requires a circulator, e.g., 1641. Port one of the circulator connects to the bidirectional port A and the second and third ports of the circulator connect, respectively, to the output 1651 and input 1652 unidirectional ports. The local added wavelength can then be coupled via circulator 1611, coupler 1601, and circulator 1641 to the output port 1651. At coupler 1601 the added wavelength is added to other optical signals from the other ports B′, C′, D′, and E′. The local dropped wavelength is selected from a signal received from the input port 1652, circulator 1641, coupler 1601 of can then be coupled via circulator 1611, coupler 1601, circulator 1641 to the output port of the unidirectional ports, i.e., A.′

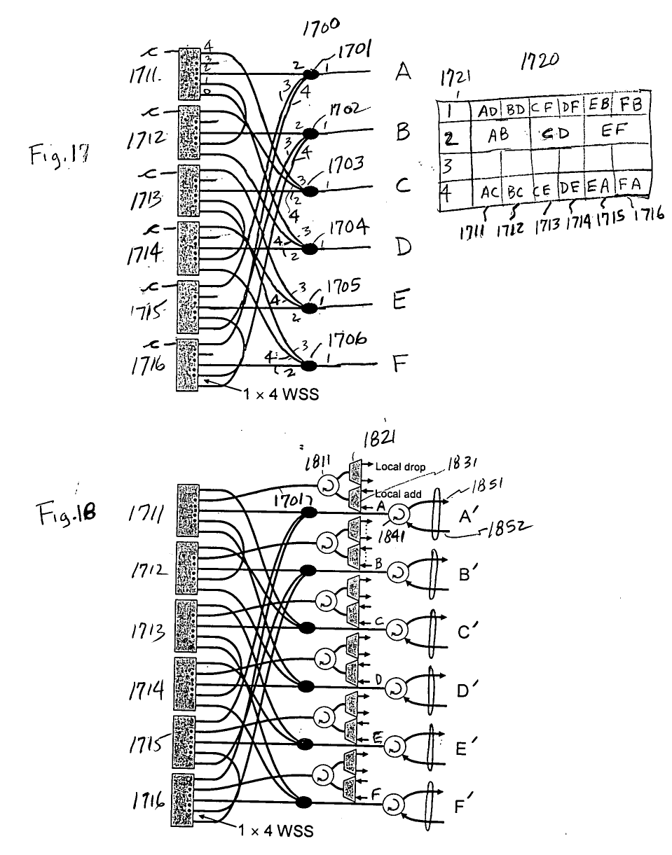

FIG. 17 illustratively shows an embodiment of our inventive degree-6 mesh node with bi-directional ports and without local add/drop. Our degree-5 non-blocking mesh node 300 has node ports A-F provides a bidirectional facility connection and does not include an add/drop capability. Each of the bidirectional ports A-F couple a single wavelength of a multiple wavelength WDM signal (also referred to as traffic) to one of the 1×4 directional coupler 1701-1706, respectively. Each of the couplers provides connection to three different 1×4 WSSs of the six-1×4 WSSs 1711-1716. Again the connection dots shown in the six 1×4 WSSs illustrate the various connections that occur in the four switching states. For each of the six 1×4 WSSs 1711-1715, the five terminals are numbered from bottom to top as terminals 0-4. The four switching states 1 to 4 are represented by the four connection dots ordered from bottom to top, respectively. As discussed below there is a particular repeating pattern in the connections between the six couplers, 1701-1706, and the six 1×3 WSSs, 1711-1716.

In FIG. 17 the six node ports A-F, six couplers 1701-1706, and six 1×4 WSSs 1711-1716 are shown arranged in column form. Each location or position is associated with (or connected to) one node port (e.g., node A), one coupler (i.e., coupler 1701), and one 1×4 WSS (i.e., 1711). A control signal c is used to select the switching state of each 1×4 WSS. However, to simplify FIG. 17 a control signal c is shown only for 1×4 WSS 1711, although it should be understood that each of the other 1×4 WSSs 1712-1715 would also have a control signal c connected to each of them. The 1×4 WSS 1711 has its five terminals numbered 0-4 from bottom to top. Thus the bottom terminal one is numbered 0, the second terminal is numbered 1, etc. The terminals of the other 1×4 WSS 1712-1716 are similarly numbered, although to avoid crowding of FIG. 17, the terminal numbers have not been shown. The couplers all follow a repeatable predefined connection arrangement to the four 1×4 WSSs that they connect to. For the purposes of our discussion of the repeatable predefined patterns of interconnection between the couplers 1701-1706 and the 1×4 WSSs, 1711-1716, we describe the numbering positions of the 1×4 WSSs, 1711-1716, as being in positions 1 to 6 and the next position count beyond 6 would “wrap around,” (as in a modulo-6 counter) to position 1. Thus for example, the 1×4 WSS in position 4 (1714) in the column is located three positions away from the 1×4 WSS in position 1 (1711) and the 1×4 WSS in position 1 (1711) is located three positions away from the 1×4 WSS in position 3 (1713).

The first coupler, e.g., 1701, has a first terminal connected to a node port A and a second terminal connected to a third terminal (shown as 2) of a first 1×4 WSS, e.g., 1711. A third terminal of the coupler, 1701, connects to a fifth terminal (top terminal, shown as 4) of a fifth 1×4 WSS, i.e., 1714. The third terminal of a coupler 1701 connects to the fifth terminal (marked as terminal 4) of a 1×4 WSS 1715 that is four positions below the coupler 1701 position. A fourth terminal of the coupler, 1701, connects to a fifth terminal (shown as 4) of a sixth 1×4 WSS, i.e., 1716, in the column. The fourth terminal of a coupler 1701 connects to the fifth terminal (marked as terminal 4) of a 1×4 WSS 1716 that is five positions below the coupler 1701 position. As will be discussed in the following paragraphs, this particular repeating pattern of coupler terminal to 1×4 WSS terminal connection is the same for all odd numbered couplers 1701, 1703, 1705.

The second coupler, e.g., 1702, has its first terminal connected to a node port B and a second terminal connected to a third terminal (shown as 2) of a second 1×4 WSS, e.g., 1712, having the same relative column position (second position) as the node port B's column position. A third terminal of the coupler, 1702, connects to a first terminal (shown as 0) of a fifth 1×4 WSS, i.e., 1715. The third terminal of a coupler 1702 connects to the first terminal (marked as terminal 0) of a 1×4 WSS 1715 that is three positions below the coupler 1702 position. A fourth terminal of the coupler, 1701, connects to a first terminal (shown as 0) of a sixth 1×4 WSS, i.e., 1716, in the column. The fourth terminal of a coupler 1702 connects to the first terminal (marked as terminal 0) of a 1×4 WSS 1716 that is four positions below the coupler 1702 position. As will be discussed in the following paragraphs, this particular pattern of coupler terminal to 1×4 WSS terminal connection is the same for all even numbered couplers 1702, 1704, 1706.

As noted above, in the following discussion the terminals three and four of the odd numbered couplers 1701, 1703, 1705 will have the same connection pattern to the 1×4 WSSs and all of the terminals three and four of the even numbered couplers 1702, 1704, 1706 will have the same connection pattern to the 1×4 WSSs. Thus the above particular terminal connection pattern described for couplers 1701 and 1702 is repeated for each pair of couplers 1703/1704 and 1705/1706. A connection exists between the second terminals (shown as terminal 1) of each pair of 1×4 WSSs, namely, 1711/1712, 1713/1714, and 1715/1716. The fourth terminal (shown as terminal 3) of each of the 1×4 WSSs 1711-1716 is not connected. As will be discussed this terminal is used to provide a local add/drop capability.

As a result the mesh node of FIG. 17 provides fifteen unique node-port pair connections (N!/[2!(N−2)!], where N=6). The fifteen unique node-port pair connections are shown in Table 1720, which shows that in state 1 the node-port pair connections for the 1×4 WSSs, 1711-1716, are AD, BD, CF, DF, EB, FB, respectively. In state 2, the node-port pair connections for the 1×4 WSSs 171 and 1712; 1713 and 1714; and 1715 and 1716 are AB, CD, EF, respectively. In state 3, there are no node-port pair connections. In state 4, the node-port pair connections for the 1×4 WSSs, 1711-1716, are AC, BC, CE, DE, EA, FA, respectively. Note that in states 1 and 3 there are six node-port pair connections, and in state 2 only three node-port pair connections. In actual operation, all of the 1×4 WSSs 1711-1716 are not in the same state. Thus for example, a signal at node port A that is to be switched to only node port B would have WSSs 1711 and 1712 in state 2, WSSs 1715 and 1716 in other than state 4, and WSSs 1713-1714 in any state 1-4. As will be discussed in FIG. 18, state 3 is used to provide for the local add/drop feature at each of the ports A-F.

While the degree-6 mesh node of FIG. 17 has been described as using six 1×4 WSSs it should be understood that, more generally, any larger 1×K WSSs may be used, i.e., where K is larger than 4 and where the additional terminals are left unconnected. Additionally, the additional unconnected terminal(s) may be located at either end or both ends of the WSSs. Of course when K is greater than 4, only two of the K switching states are used, the same switching states as used in the six 1×4 WSSs embodiment of FIG. 17.

FIG. 18 illustratively shows an embodiment of our inventive degree-6 mesh node having separate unidirectional ports, e.g., A′, and local add/drop at each location. It should be noted that separate unidirectional ports, e.g., A′ and/or a local add/drop capability can be provided at less than all of the six port locations A-F. The separate unidirectional ports capability requires a circulator, e.g., 1841, at each of the bidirectional output ports, i.e., A, to couple unidirectional signals ports, i.e., A′ to/from the degree-6 mesh node.

Local add/drop capability is also provided at each of the node ports A-F using a separate circulator. Thus, one port of each of the circulators, e.g., 1811, connects to one of the local drop demultiplexer, e.g., 1821. Another port of each of the circulators, e.g., 1811, connects to one of the local add multiplexer, e.g., 1831. The third port of each of the circulators, e.g., 1811, connects to the fourth terminal (shown as terminal 3) of each of the 1×4 WSS, e.g., 1711. The local add wavelength can then be coupled via circulator 1811, through the fourth to third terminal connection in 1×4 WSS 1711 (during switch state 3) to circulator 1841 to output port 1841 of A′. The local drop wavelength is selected from a signal received from the input port 1852, circulator 1841, through the third to fourth terminal connection in 1×4 WSS 1711 (during switch state 3), to circulator 1811 and demultiplexer 1821.

It should be understood that this invention is not limited to the particular embodiments disclosed, but it is intended to cover modifications within the spirit and scope of the present invention as defined by the appended claims.

### APPENDIX

### Proof that Simplified Degree-4 Design Using a Single Reflective WSS is Optimum

In the simplified degree-4 1-D design (FIGS. 10 and 13) we used two splitters and seven ports on the WSS. Here we show that no design could use fewer splitters or ports.

Suppose no splitters were used. Without loss of generality assume that the ports on the WSS connect to locations A, B, C, and D in that order from left to right. Then a dot (mirror tilt angle) that connects A and B lies between the ports connected to A and B. But that means that C and D are both to the right of the dot and hence are not connected. Thus there must be at least one splitter.

Suppose there is exactly one splitter. Without loss of generality assume that C is the location that gets split (and hence C is connected to two ports of the WSS), and that the left to right ordering of the lines other than the two C's is ABD. Then there is a dot connecting A and B, and this implies that there must be a C to the left of A so as to be able to connect this C via this dot to D. The dot that connects B with D must lie to the right of B and so it must connect A with a copy of C to the right of D. Thus the ordering is CABDC. Then the dot that connects A and D cannot connect B to either C. So there must be at least one more splitter.

Since we have that there must be at least two splitters, then there must be at least six ports in the WSS. Suppose there are exactly six. Then all ports have a line into them, and so no dot occurs at a port position (otherwise there will be a location routed back to itself). Also, any dot must have at least two ports on either side of it. Then the three necessary dots must occur between ports 2 and 3 (dot 1), between ports 3 and 4 (dot 2), and between ports 4 and 5 (dot 3). But then dot 2 will create three connections contradicting the criterion that each dot should connect two pairs. Thus six ports are insufficient.

### REFERENCES

¹C. R. Doerr, L. W. Stulz, D. S. Levy, M. Cappuzzo, E. Chen, L. Gomez, E. Laskowski, A. Wong-Foy, and T. Murphy, “Silica-waveguide 1×9 wavelength-selective cross connect,” Optical Fiber Communication Conference, postdeadline paper FA3, 2002.
²D. M. Marom, et. al., “Wavelength-selective 1×4 switch for 128 WDM channels at 50 GHz spacing,” Optical Fiber Communication Conference, paper FB7, 2002.
³D. M. Marom, C. R. Doerr, N. R. Basavanhally, M. Cappuzzo, L. Gomez, E. Chen, A. Wong-Foy, and E. Laskowski, “Wavelength-selective 1×2 switch utilizing a planar lightwave circuit stack and a MEMS micromirror array,” Optical MEMS 2004, Takamatsu, Japan, Aug. 2004.
⁴T. Ducellier, A. Hnatiw, M. Mala, S. Shaw, A. Mank, D. Touahri, D. McMullin, T. Zami, B. Lavigne, P. Peloso, and O. Leclerc, “Novel high performance hybrid waveguide-MEMS 1×9 wavelength selective switch in a 32-cascade loop experiment,” European Conference on Optical Communications, postdeadline paper Th4.2.2, 2004.
⁵J. M. Simmons, A. A. M. Saleh, E. L. Goldstein, and L. L. Lin, “Optical crossconnects of reduced complexity for WDM networks with bidirectional symmetry,” IEEE Photon. Technol. Lett., vol. 10, p. 819-821, Jun. 1998.

We claim:

1. A non-blocking N port optical connection mesh node, 3<=N<=4, for providing a multiple wavelength channel signal with reciprocal connectivity between node ports, comprising
one reflective 1×K WSS apparatus, where K is at least equal to 3N−6, having K+1 or less terminals and switch states being selectable in response to a control signal, where the control signal activates three switch states, one switch state providing a first switch connection of a first terminal-pair and at least one other switch state providing a second switch connection of a second terminal-pair, both terminals in the second pair different than the terminals in the first pair and
node port connection means for providing reciprocal connectivity between each of the N node ports and terminals of the 1×K WSS apparatus, so that the three switch states activated by the control signal provide a set of at least one unique node-port pair connection.

2. The optical mesh node of claim 1, where N equals 4 and K is equal to 6 and the 1×6 WSS apparatus includes
a 1×6 WSS, having a first and a second predetermined terminals connected to a first and second node ports, respectively,
a first 1×2 directional coupler having an input port connected to a third node port and each of its output ports connected to a predetermined terminal of the 1×6 WSS, and
a second 1×2 directional coupler having an input port connected to a fourth node port and each of its output ports connected to a predetermined terminal of the 1×6 WSS.

3. The optical mesh node of claim 2, where optical attenuators or dummy couplers are added to equalize the losses for all possible port connections.

4. The optical mesh node of claim 1, further comprising at each of the N node ports
a circulator having a first circulator port connected to that node port for coupling a received signal from that node port for output at a second circulator port and for coupling a received signal at a third circulator port for output to that node port.

5. The optical mesh node of claim 1, further comprising at each of the N node ports having an add and drop wavelength capability
a circulator having a first circulator port connected to that node port;
a first 1×2 coupler having an input port for receiving a multiple wavelength channel signal, a first output port for coupling the input signal to a third circulator port, and a second output port for coupling the input signal to a drop demultiplexer and
the drop demultiplexer for selectively dropping one or more wavelengths of the input signal; and
a second 1×2 coupler having a first input port for receiving a signal from the second circulator port, a second input port for receiving a signal from an add multiplexer, and an output port for outputting a multiple wavelength channel signal and
the add multiplexer for selectively adding one or more wavelengths to the output port of the second 1×2 coupler.

6. The optical mesh node of claim 1, where K=9 and N=4, wherein the one reflective 1×9 WSS includes a two-dimensional array of node ports having 5 terminals on each of two levels and includes a two-dimensional tilt mirror, the optical mesh node further comprising
a first 1×2 coupler having an input port connected to a first node port and each of its output ports connected to a unique port of a different level of the ×9 WSS;
a second 1×2 coupler having an input port connected to a second node port and each of its output ports connected to a unique port of a different level of the 1×9 WSS,
a third 1×2 coupler having an input port connected to a third node port and each of its output ports connected to a unique port of a different level of the 1×9 WSS, and
an attenuator or a fourth 1×2 coupler having an input port connected to a fourth node port and an output port connected to a unique port of the 1×9 WSS.

7. The optical mesh node of claim 6 where the 1×2 couplers have a 0.50 coupling ratio and the attenuator has a 3-dB loss.

8. The optical mesh node of claim 6, further comprising at at least one of the N node ports
a circulator having a first circulator port connected to that node port for coupling a received signal from that node port to a second circulator port and for coupling a received signal at a third circulator port for output to that node port.

9. A partitioned four port optical connection mesh node for providing a multiple wavelength channel signal with reciprocal bidirectional connectivity between ports, N=4, the node ports portioned into two sets each set containing two node ports, comprising
one reflective 1×K WSS, having K+1 terminals of which three are directly connected to three of node ports, where K is greater than or equal to N, containing a steerable mirror for each wavelength channel which can be switched to one of K positions, the 1×K WSS is switched to one of two switch states in response to a control signal;
one directional 1×2 coupler connecting 2 predesignated terminals on the 1×K WSS to a preselected one of the node ports; and
wherein each switchable state enables the 1×K WSS to make a connection from any of the 2 node ports in one set to any of the other 2 node ports in the other set.

10. The optical mesh node of claim 9, further comprising at at least one of the 4 node ports
a circulator having a first circulator port connected to that node port for coupling a received signal from that node port for output at a second circulator port and for coupling a received signal at a third circulator port for output to that node port.

11. The optical mesh node of claim 9 further comprising
at at least one of the N node ports having an add and drop wavelength capability
a 1×2 coupler having an input port for receiving an input signal, a first output port for coupling the input signal to the first port of the circulator, and a second output port for coupling the input signal to a drop demultiplexer;
the drop demultiplexer for selectively dropping one or more wavelengths of the input signal; and
a ROABM having an input port for receiving a signal from the third port of the circulator, a plurality of input ports each for receiving one or more selected input wavelength signals, and an output port for outputting a combined signal from the third port of the circulator plus the one or more selected input wavelength signals.

12. The optical mesh node of claim 9 where each output port of the 1×2 coupler has a 0.50 coupling ratio.

13. A non-blocking N port optical connection mesh node, 5<=N<=6, for providing a multiple wavelength channel signal with reciprocal bidirectional connectivity between node ports, comprising
N port couplers, each being at least a 1×3 directional coupler and having an input port connected to a different one of the N ports, each of 3 output ports connected to one of N reflective 1×K WSSs, where K=N−2;
each of the N reflective 1×K WSSs being responsive to a control signal for establishing a plurality of switching states, the N reflective 1×K WSSs and N port couplers being interconnected so that in response to the establishment of each switch state of the N reflective 1×K WSSs a plurality of unique node-port pair connections are made, and wherein all of the N!/[2!(N−2)!] unique node-port pair connections are made during the plurality of switching states of the N reflective 1×K WSSs.

14. The N port optical connection mesh node of claim 13, where N=5 and K=3 wherein
each port coupler has each of its three output ports connected to a different terminal of different one of the N reflective 1×K WSSs.

15. The N port optical connection mesh node of claim 13, where N=5 and K=3 wherein
at least one of the N port couplers is a 1×4 directional coupler where a fourth output port connects to an local wavelength add/drop apparatus.

16. The N port optical connection mesh node of claim 13, where N=5 and K=3 wherein
at least one of the bidirectional N ports includes a circulator having a first circulator port connected to the bidirectional node port for coupling a received signal at the first circulator port to a second circulator port for output to a first unidirectional facility and for coupling a received signal from a second unidirectional facility at a third circulator port to the first circulator port.

17. The N port optical connection mesh node of claim 13, where N=6 and K=4 wherein
each odd numbered port coupler has each of its three output ports connected to a different terminal of different one of the N reflective 1×K WSSs and each even numbered port coupler has a first port connected to a terminal of a first reflective 1×K WSS and a second and a third ports are connected to different terminals of the same second reflective 1×K WSS.

18. The N port optical connection mesh node of claim 13, where N=6 and K=4 wherein
at least one of the N reflective 1×K WSSs has a terminal that connects to an local wavelength add/drop apparatus during one of the switching states of said one of the N reflective 1×K WSSs.

19. The N port optical connection mesh node of claim 13, where N=6 and K=4 wherein
at least one of the bidirectional N ports includes a circulator having a first circulator port connected to the bidirectional node port for coupling a received signal at the first circulator port to a second circulator port for output to a first unidirectional facility and for coupling a received signal from a second unidirectional facility at a third circulator port to the first circulator port.

20. The N port optical connection mesh node of claim 13, where N=6 and K=4 wherein
each of the odd numbered reflective 1×K WSSs has a terminal that connects to the same terminal of next-higher even numbered reflective 1×K WSSs.
